(19) United States
(12) Patent Application Publication
(10) Pub. No.: US 2002/0019254 A1
(43) Pub. Date: Feb. 14, 2002

(54) Gaming machine

(76) Inventor: Leonard Hastings Ainsworth, Chiswick (AU)

Correspondence Address: ARTER & HADDEN LLP, 1100 Huntington Building, 925 Euclid Avenue, Cleveland, OH, 44115-1475, US

(21) Appl. No.: 09/917,123

(22) Filed: Jul. 27, 2001

(30) Foreign Application Priority Data
Jul. 28, 2000 (AU) PQ9660

(51) Int. Cl. A63F 13/00

(52) U.S. Cl. 463/16; 463/21; 463/20; 463/22

(57) ABSTRACT

A gaming machine with a display screen 6 showing separate sets 1, 2, 3 of symbols, the gaming machine being configured to move each set 1, 2, 3 of symbols relative to each other to form a random configuration of the various symbols on the display 6 and pay winnings on the occurrence of predetermined winning configurations of the symbols, wherein the display 6 simultaneously displays all the symbols in at least one of the sets 1, 2 or 3.

### FIELD OF THE INVENTION

The present invention relates to gaming machines. The invention has been developed primarily for computerised gaming machines and will be described herein with reference to that application. However, it will be appreciated that the invention is not limited to that particular field of use and may be suitable for many applications.

### BACKGROUND OF THE INVENTION

Gaming machines have long been known and are now one of the most common forms of gambling. One of the oldest and best known forms of gaming machine is the rotating reel type “poker machine”. These machines use a series of three, four or five reels, each reel having symbols on its peripheral edge. The reels are rotated upon the placement of a wager and then stopped to produce a randomly selected arrangement of symbols. Winnings are paid if the random arrangement of symbols matches one of the predetermined winning combinations.

Gaming machines can “pay winnings” in a variety of ways. These include dispensing money, dispensing tokens that can be redeemed for money and adding credits to a credit meter that can be used for placing bets or redeemed for money. The winnings may even entail awarding the player one or more “free games” whereby the machine operates without the player needing to place a bet. Therefore throughout the specification the use of terminology such as “winnings are paid”, “pay winnings” and so on will denote the award of some type of benefit or desirable outcome to the player.

Recently these gaming machines have been computerised with a video display screen replacing the physically rotating reels. The display screen typically presents an array of symbols in five columns and three rows equating to the symbols that would normally be seen on five rotating reels of an old style mechanical machine.

During a game, the video display moves the symbols up or down the screen to simulate the spinning of actual reels. The user is largely disinterested in this phase of the game and only becomes attentive again when the moving symbols are stopped and the random array is presented. However, to remove this phase such that the random array appears immediately upon placing a wager, would be an uncomfortable departure from the traditional gaming machine experience.

### SUMMARY OF INVENTION

In accordance with the present invention there is provided a gaming which overcomes and ameliorates at least one of the disadvantages of the prior art, or to provide a useful alternative.

Further, in accordance with the present invention, there is a gaming machine comprising:

a display adapted to show separate sets of symbols;

means adapted for moving each set of symbols relative to each other to form a random arrangement of the symbols on the display; and

means adapted for paying winnings on the occurrence of predetermined winning arrangements of the symbols; wherein the display simultaneously displays all the symbols in at least one of the sets.

Still further, in accordance with the present invention, there is provided a method of operation for a gaming machine having a display adapted to show separate sets of symbols, the method comprising:

moving each of the sets of symbols relative to each other to form a random arrangement of the symbols on the display; and,

paying winnings on the occurrence of predetermined winning arrangements of the symbols, such that all of the symbols in at least one of the sets is simultaneously shown on the display.

Preferably each set is a series of the symbols arranged side by side along respective paths through the display, wherein at least one of the paths forms an enclosed shape such that the display moves the symbols of each set along the respective paths in order to produce the random arrangements and any of the paths in the form of an enclosed shape has all its symbols simultaneously displayed.

In a further preferred embodiment, the paths are concentric circles and the symbols of each of the sets move around their respective circles in a direction opposing that of an adjacent circle in order to produce the random arrangement of symbols.

In a particularly preferred embodiment, the random arrangement of symbols shown on the display aligns at least one of the symbols from each of the sets along a diameter of the outermost circle; and winnings are paid upon the occurrence of predetermined winning combinations of symbols along the diameter. In other embodiments, symbols from each of the sets are aligned along at least two diameters of the outermost circle and winnings are paid on the occurrence of predetermined winning combinations of symbols along any one of the at least two diameters.

In another embodiment, the random arrangement of symbols shown on the display is positioned such that at least one symbol from each of the sets is within a specified segment of the outermost circle, and winnings are paid on the occurrence of predetermined combinations of symbols within the specified segment. In one preferred embodiment, the specified segment is a quadrant of the outermost circle.

It will be appreciated that gaming machines according to the present invention provide a complete view of all the symbols in one or more of the reels and not just the symbols at the “front” of the reels. This allows the player to watch the symbols required for any particular winning combination to move into, as well as out of, the area assessed for winnings. Accordingly, the player will feel a sense of anticipation as certain symbols move toward the winnings area, and possibly some uncertainty as to whether the symbol will still be in the winnings area when the sets of symbols come to a halt. This provides an enhanced gaming experience for the player who would normally be disinterested in the simulated movement of the rotating reels.

### BRIEF DESCRIPTION OF THE DRAWINGS

The invention will now be described, by way of example only, with reference to the specific embodiments shown in the accompanying drawings in which:

FIG. 1 shows a schematic representation of the symbols presented in accordance with a basic form of the present invention; and

FIG. 2 shows a schematic representation of the configuration of symbols presented in accordance with another form of the present invention.

### DETAILED DESCRIPTION OF PREFERRED EMBODIMENTS

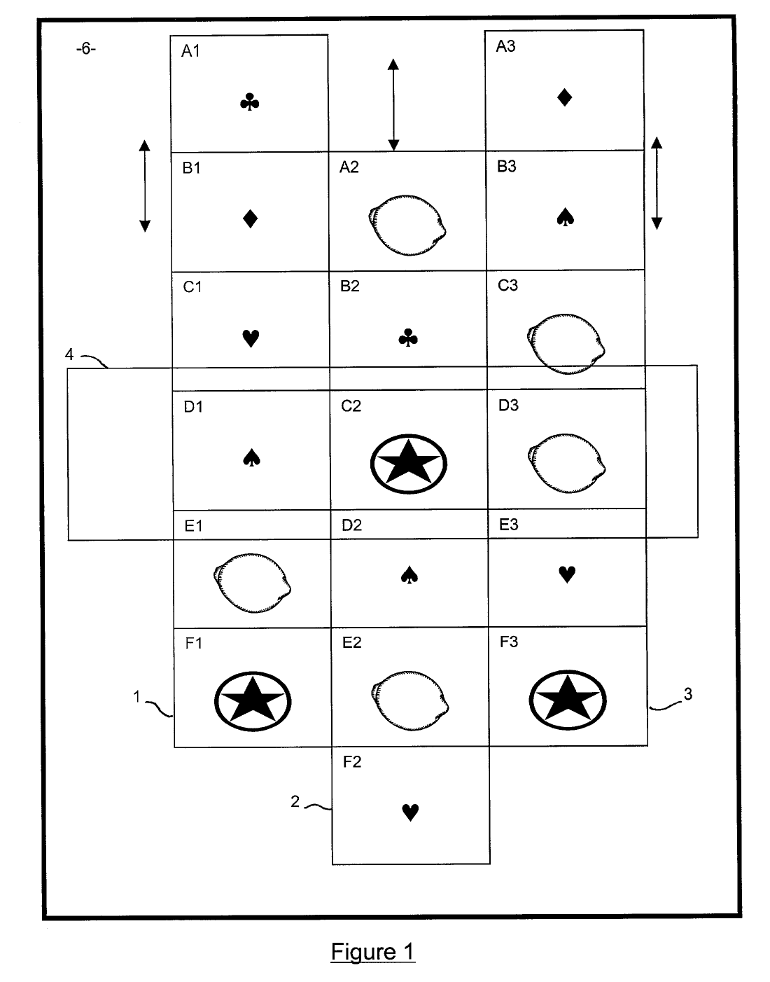

Referring to FIG. 1, a basic form of the display 6 of a gaming machine according to the present invention is shown. Three separate sets, 1, 2 and 3 of various symbols, A1 to F1, A2 to F2, and A3 to F3, are moved relative to each other across the display screen upon the placement of a wager. After a period of time, each of the sets 1, 2 and 3 are brought to a halt such that at least one of the symbols from each set (in this case D1, C2 and D3) is enclosed within the area 4 commonly known as a “game line” or “pay line”. Winnings are paid in accordance with the occurrence of predetermined combinations appearing in the pay line 4.

All of the symbols in at least one of the sets 1, 2 or 3 are visible on the display screen when the movement of the sets is brought to a halt. In this way the player can get some appreciation for whether or not they narrowly missed out on a winning combination appearing in the pay line 4. Alternatively, the player can get a sense of anticipation by watching as certain symbols that are required in a winning combination approach the pay line 4.

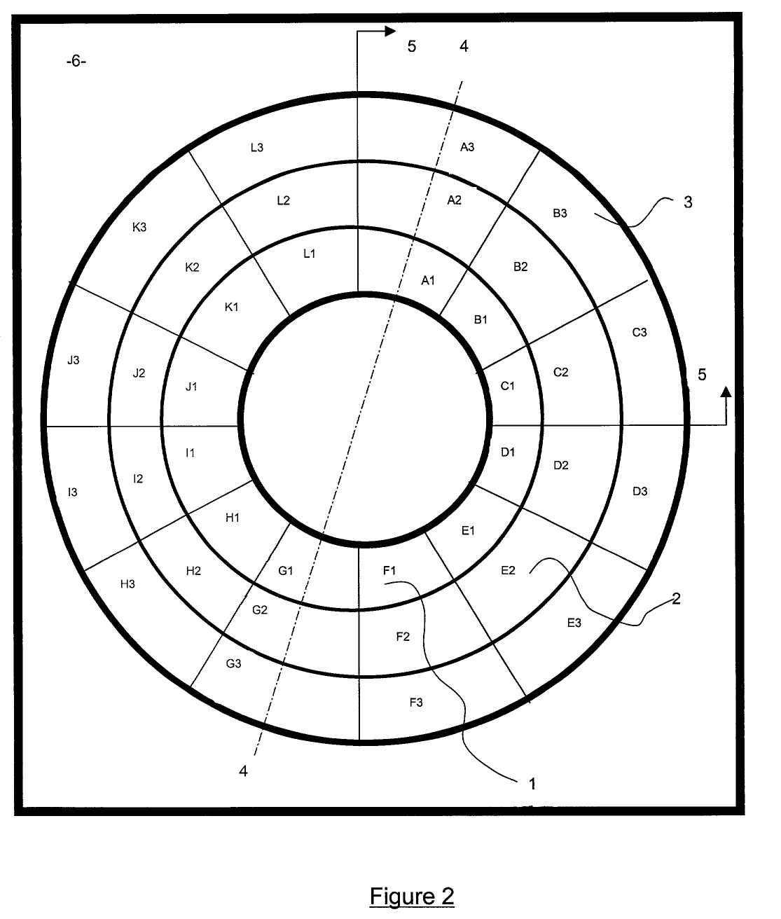

FIG. 2 shows a slightly more complex form of the display of a machine according to the present invention. The separate sets of symbols 1, 2 and 3 are arranged in concentric circles. Each set is rotated relative to the other sets to produce the random configuration of symbols. Conveniently, the circles are suitably be rotated in a direction opposite to that of the adjacent circle. However, it is understood that in another embodiment, the circles are rotated in the same direction but at a different speeds.

The gaming machines suitably provide a pay line along a diameter 4-4 of the outermost circle 3. Of course, at least one symbol from each set 1, 2 and 3 would need to align with the diameter 4-4 whenever the sets stop moving. Alternatively, the winnings are suitably assessed from the combinations of symbols appearing within a particular segment of the outermost circle. For example, it would be convenient to assess the combination of symbols appearing in the segment 5-5. In this case, at least one symbol from each set would have to be positioned within the quadrant 5-5 whenever the circles came to a halt.

This form of the invention serves to enhance the gaming experience by allowing the player to simultaneously observe the position of all symbols during the operation of the game. It also allows the player to watch as any particular symbols approach the pay line or “pay segment” as well as leave the pay line or pay segment. This offers the player an extra dimension of involvement with the game while the display screen 6 moves the symbols into the random configuration.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What we claim is:

1. A gaming machine comprising:
a display adapted to show separate sets of symbols;
means adapted for moving each of the symbols relative to each other to form a random arrangement of the symbols on the display; and,
means adapted to pay winnings on the occurrence of pre-determined winning arrangements of the symbols;
wherein the display simultaneously displays all the symbols in at least one of the sets.

2. A gaming machine according to claim 1 wherein each set is comprised of a series of the symbols arranged side by side along respective paths through the display, wherein at least one of the paths form an enclosed shape such that the display moves the symbols of each set along the respective paths in order to produce the random arrangements, and any of the paths in the form of an enclosed shape has all its symbols simultaneously displayed.

3. A gaming machine according to claim 2 wherein the paths are concentric circles and the symbols of each of the sets move around their respective circles in a direction opposing that of an adjacent circle in order to produce the random arrangement of symbols.

4. A gaming machine according to claim 3 wherein the random arrangement of symbols shown on the display aligns at least one of the symbols from each of the sets along a diameter of the outer most circle and winnings are paid upon the occurrence of pre-determined winning combinations of symbols along the diameter.

5. A gaming machine according to claim 3 wherein symbols from each of the sets are aligned along at least two diameters of the outermost circle and winnings are paid on the occurrence of predetermined winning combinations of symbols along any one of the at least two diameters.

6. A gaming machine according to claim 3 wherein the random arrangement of symbols shown on the display is positioned such that at least one symbol from each set is within a specified segment of the outer most circle and winnings are paid on the occurrence of pre-determined winning combinations of symbols within the specified segment.

7. A gaming machine according to claim 6 wherein the specified segment is a quadrant of the outer most circle.

8. A method of operation for a gaming machine having a display adapted to show separate sets of symbols, the method comprising:
moving each of the sets of symbols relative to each other to form a random arrangement of the symbols on the display; and
paying winnings on the occurrence of pre-determined winning arrangements of the symbols such that all of the symbols in at least one of the sets is simultaneously shown on the display.

9. A method according to claim 8 wherein each set is a series of the symbols arranged side by side along respective paths through the display wherein at least one of paths forms an enclosed shape, and the display moves the symbols of each set along the respective paths in order to produce the random arrangements such that any paths in the form of an enclosed shape has all its symbols simultaneously displayed.

10. A method according to claim 9 wherein the paths are concentric circles and the symbols of each set are moved around their respective circles in a direction opposing that of an adjacent circle in order to produce the random arrangement of symbols.

11. A method according to claim 10 wherein the random arrangement of symbols shown on the display aligns at least one symbol from each set along a diameter of the outer most circle, and winnings are paid upon the occurrence of pre-determined combinations of symbols along the diameter.

12. A method according to claim 10 wherein the symbols from each of the sets are aligned along at least two diameters of the outer most circle and winnings are paid on the occurrence of pre-determined winning combinations of symbols along any one of the at least two diameters.

13. A method according to claim 10 wherein the random arrangements of symbols shown on the displays position such that at least one symbol from each set is within the specified segment of the outer most circle, and winnings are paid on the occurrence of the predetermined winning combinations of symbols within the specified segment.

14. A method according to claim 13 wherein the specified segment is a quadrant of the outer most circle.
